(19) United States
(12) Patent Application Publication
(10) Pub. No.: US 2013/0287749 A1
(43) Pub. Date: Oct. 31, 2013

(54) FORMULATION FOR SNAIL BAITS COMPRISING ORGANOPHOSPHONIC ACIDS, METAL SALTS AND METHIOCARB

(71) Applicants: Wolfgang Wirth, Bergisch-Gladbach (DE); Margit Doth, Leverkusen (DE); Sybille Lamprecht, Leverkusen (DE); Hubert Schmeer, Ste Foy Les Lyon (FR)

(72) Inventors: Wolfgang Wirth, Bergisch-Gladbach (DE); Margit Doth, Leverkusen (DE); Sybille Lamprecht, Leverkusen (DE); Hubert Schmeer, Ste Foy Les Lyon (FR)

(73) Assignee: BAYER INTELLECTUAL PROPERTY GMBH, Monheim (DE)

(21) Appl. No.: 13/824,277

(22) PCT Filed: Sep. 30, 2011
(86) PCT No.: PCT/EP2011/067145

§ 371 Date: Jul. 3, 2013

Related U.S. Application Data
(60) Provisional application No. 61/390,306, filed on Oct. 6, 2010.

(30) Foreign Application Priority Data
Oct. 6, 2010 (EP) 10186661.4

(51) Int. Cl. A01N 57/20; A01N 47/22; C07F 9/38

(52) U.S. Cl. CPC A01N 57/20; C07F 9/38; A01N 47/22
USPC 424/93.51; 514/121; 514/108

(57) ABSTRACT

The present invention relates to novel phosphonic acid formulations and to their use as slug and snail baits, and to the corresponding slug and snail baits, to a process for their preparation and to their use for controlling slugs and snails.

The present invention relates to novel phosphonic acid formulations and to their use as slug and snail baits, and to the corresponding slug and snail baits, to a process for their preparation and to their use for controlling slugs and snails.

It is already known to control terrestrial slugs and snails with the aid of baits which contain feedants and molluscicidal active substances such as methiocarb, metaldehyde or metal chelates (cf. DE 35 03 608A, DE 36 12 161A, WO 96-05 728A, WO 97-26 789A, WO 99-25 194A, WO 99-39 576A and WO 00-11 948A). However, the activity of the metal chelates is not always satisfactory.

Slug and snail baits based on phosphonic acids are already known from EP-A 1,599,094. Said document also describes that these slug and snail baits may, if appropriate, contain further molluscicidal active substances such as methiocarb, metaldehyde and metal salts, if appropriate as a mixture with complexing agents, such as chelates of ethylene diamine tetraacetic acid and iron ions and/or copper ions.

However, the activity of the baits based on phosphonic acids, in respect of the protection of the plant against feeding damage and in respect of the destruction rate of the slugs and snails is not always satisfactory and frequently worse than that of methiocarb. It cannot be improved by varying the percentage content of phosphonic acid, either.

The good activity of carbamates is well known. The toxicological profile of the carbamates, however, is less favourable than that of phosphonic acids. This is why existing methiocarb products come more and more under pressure in terms of their regulation. The consequence is that they are employed within severe limitations (for example in Germany only “under glass”).

Therefore, there continues to exist a need for slug and snail baits which are improved with regard to their efficacy and toxicology, and which, besides good protection of the crop plant, also demonstrate more advantageous toxicological properties than pure carbamates when employing phosphonic acid.

There have now been found novel phosphonic acid formulations which, owing to the addition of a certain amount of methiocarb, demonstrate better protection against feeding damage than pure phosphonic acid formulations.

The present invention therefore relates to phosphonic acid formulations containing
a) phosphonic acids of the formula (I)

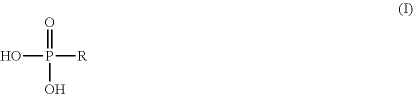

in which R represents C₁-C₁₀-alkyl,
which is monosubstituted or polysubstituted by identical or different substituents from the series consisting of PO₃H₂, CO₂H, OH, NH₂, CN, halogen, C₁-C₈-alkylamine or C₂-C₁₆-dialkylamine and
which is optionally interrupted by 1-6 heteroatoms from the series consisting of N, O, S, P, with heteroatoms not being linked directly to each other;
and
ammonium, alkali metal, alkaline-earth metal and/or iron salts;
and/or
b) ammonium, alkali metal, alkaline-earth metal salts
   and/or iron salts of the phosphonic acids of the formula (I)
   and
c) methiocarb,
   characterized in that the amount of a) and/or b) is from 0.5 to 10% by weight and the amount of c) is in the range of from 0.1 to 1% by weight.

The slug and snail baits according to the invention are characterized by the abovementioned constituents.

The active components which are present in the slug and snail baits according to the invention are either
a) one or more ammonium, alkali metal, alkaline-earth metal salts
   and/or iron salts of the phosphonic acids of the formula (I),
or
b) one or more ammonium, alkali metal, alkaline-earth metal salts
   and/or iron salts of the phosphonic acids of the formula (I) in admixture with one or more magnesium, calcium and/or iron salts
Or
c) phosphonic acids of the formula (I) in the mixture with one or more magnesium, calcium and/or iron salts.

Preferred phosphonic acids are those of the formula (Ia)

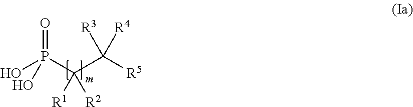

in which
R¹, R², R³, R⁴ and R⁵ independently of one another in each case represent hydrogen, C₁-C₄-alkyl, CO₂H, CH₂CO₂H, PO₃H₂, OH, halogen, CN, NH₂ and
m represents the numbers 0, 1, 2, 3, 4 or 5.
R¹, R², R³, R⁴ and R⁵ independently of one another preferably represent in each case hydrogen, methyl, ethyl, n-propyl, iso-propyl, n-butyl, iso-butyl, sec-butyl, tert-butyl, PO₃H₂, CO₂H, CH₂CO₂H, OH.
m preferably represents the numbers 0, 1 or 2.
Likewise preferred are phosphonic acids of the formula (Ib)

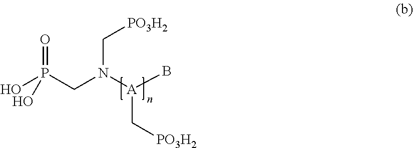

in which
A represents C₁-C₆-alkyl, C₁-C₆-alkylamino, C₁-C₆-alkoxy, where two heteroatoms are not bonded directly to each other,
B represents H, OH, CH₂PO₃H₂, CN, halogen, NH₂, C₁-C₈-alkylamine or C₂-C₁₆-dialkylamine,
n represents the numbers 0, 1, 2, 3, 4.
A preferably represents the following groups:

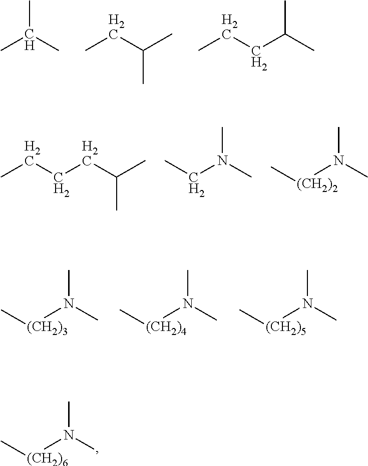

where the carbon atom shown on the left is bonded to the nitrogen in formula (Ib).
B preferably represents H, OH or CH₂PO₃H₂.
n preferably represents the numbers 0, 1 or 2.

These definitions of radicals can be combined as desired among each other, that is to say combinations between the stated preferred ranges are also possible. Likewise, individual definitions may not be taken into consideration. Preferred in accordance with the invention are the compounds of the formula (I) in which there exists a combination of the meanings mentioned above as being preferred. The definitions of radicals mentioned above in general terms or in preferred ranges apply not only to the end products of the formula (I), but also correspondingly to the starting materials or intermediates required in each case for the preparation.

Especially preferred is the compound of the formula (I-1)

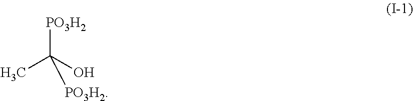

Likewise especially preferred is the compound of the formula (I-2)

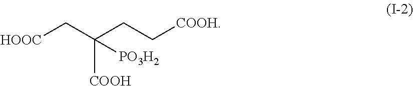

Likewise especially preferred is the compound of the formula (I-3)

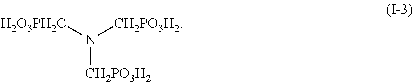

Likewise especially preferred is the compound of the formula (I-4)

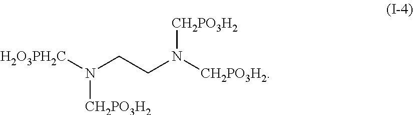

Likewise especially preferred is the compound of the formula (I-5)

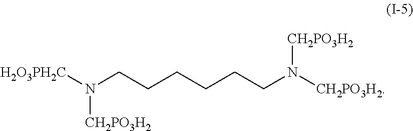

Likewise especially preferred is the compound of the formula (I-6)

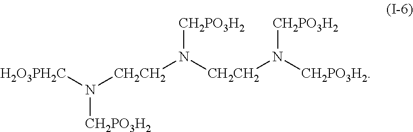

Likewise especially preferred is the compound of the formula (I-7)

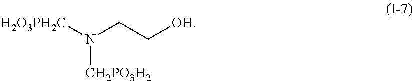

Suitable salts of the phosphonic acids are preferably their ammonium, lithium, sodium, potassium, magnesium, calcium, iron(II) and iron(III) salts. These salts may take the form of uniform or mixed salts. Uniform salts are understood in this context as meaning those salts which only contain one of the abovementioned cations. Mixed salts are understood as meaning those salts which contain a variety of the abovementioned cations. Other salts which are also suitable are those in which not all H₂O₃P groups of the phosphonic acids are present in salt form.

The phosphonic acids of the formula (I) and their salts are known or can be prepared by known methods.

Besides the phosphonic acid of the formula (I) and/or its salts, the slug and snail baits according to the invention may also contain one or more magnesium, calcium and/or iron salts.

Salts of the abovementioned metals which are suitable are, preferably, sulphates, carbonates and phosphates. Examples which may be mentioned are magnesium sulphate, magnesium carbonate, calcium sulphate, calcium carbonate, iron(II) sulphate, iron(III) sulphate, iron(II) hydrogen sulphate, iron(III) hydrogen sulphate, iron(II) hydrogen phosphate, iron(III) hydrogen phosphate, iron(II) hydrogen carbonate, iron(II) phosphate, iron(III) phosphate, iron(II) carbonate and iron(III) carbonate. The salts may be present in the form of hydrates or in anhydrous form. Especially preferred are iron(II) phosphate, iron(III) phosphate, iron(II) hydrogen phosphate, iron(III) hydrogen phosphate, iron(II) dihydrogen phosphate and iron(III) dihydrogen phosphate.

Cereal meals which may be present in the slug and snail baits according to the invention are commercially available meals such as wheatmeal, rye meal, rice starch and the like. Preferred are hard wheatmeal and soft wheatmeal. The meal is present in finely particulate form, preferably in particle sizes of below 250 m.

Binders which may be present in the baits according to the invention are all customary adhesives which can be used for the preparation of such products. Those which are preferably suitable are modified starch, formaldehyde-releasing substances, optionally partially hydrolysed polyvinyl acetate and/or molasses.

Modified starch is understood as meaning, in the present case, commercially available products of this type. A preferred substance is cold-swelling cornstarch.

Formaldehyde-releasing substances which may be present are all customary products which are suitable for releasing formaldehyde. Preferred are urea/formaldehyde condensates. Suitable polyvinyl acetates, which may optionally be present in partially hydrolysed form, are preferably the products known by the trade names Mowilith® (by Clariant) and Mowiol® (by Clariant).

Molasses are understood as meaning, in the present case, customary syrup-like mother liquors which are generated in sugar production.

Suitable supplementary agents which may be present in the baits according to the invention are, preferably, preservatives, colourants, slug and snail attractants, grinding auxiliaries, additives, bittering agents, repellents for warm-blooded species and anti-caking agents, and also synthetic aromas, water and further molluscicidal active substances.

Suitable preservatives are all customary substances which are suitable for this purpose. Substances which may be mentioned by preference are 2-hydroxybiphenyl, sorbic acid, p-hydroxybenzaldehyde, methyl p-hydroxybenzoate, benzaldehyde, benzoic acid, propyl p-hydroxybenzoate and p-nitrophenol.

Colourants which are suitable are all customary substances which are suitable for this purpose. Substances which may be mentioned by preference are inorganic pigments such as iron oxide, titanium dioxide and Prussian Blue, and organic dyestuffs, such as anthraquinone, azo and metal phthalocyanin dyestuffs.

Suitable slug and snail attractants are all customary substances which are suitable for this purpose. Examples which may be mentioned are plant extracts and their downstream products, and products of animal origin.

Suitable grinding auxiliaries are all substances which are suitable for this purpose. Examples which may be mentioned are kaolins, clays, talc, chalk, quartz powder and highly disperse silica.

Suitable additives are substances which are suitable for adjusting the pH in the bait preparations. An example which may be mentioned is citric acid.

Suitable bittering agents are all substances which are conventionally employed for this purpose. An example which may be mentioned is denatonium benzoate.

Suitable repellents for warm-blooded species, which have a repellent effect on warm-blooded organisms such as dogs or hedgehogs, are all substances which are conventionally used for this purpose. An example which may be mentioned is nonyl vanillylamide.

Suitable anti-caking agents are all substances which are conventionally used for this purpose and which prevent agglomeration and caking. Examples which may be mentioned are moisture-absorbing powders such as kieselguhr, pyrogenic silicas, tricalcium phosphate, calcium silicates, alumina, magnesium oxide, magnesium carbonate, zinc oxide, stearates and fatty amines

Besides at least the abovementioned molluscicidal active substances, the slug and snail baits according to the invention may contain additional molluscicidal active substances. Suitable additional molluscicidal active substances are all substances which are suitable for this purpose. An example which may be mentioned is metaldehyde.

The content of the individual components in the slug and snail baits according to the invention can be varied within a certain range. Thus, the concentrations
of phosphonic esters of the formula (I) and/or their ammonium, alkali metal, alkaline-earth metal and/or iron salts,

if appropriate as a mixture with one or more magnesium, calcium and/or iron salts, are generally between 0.5 and 10% by weight, preferably between 1.0 and 4.0% by weight,
of methiocarb between 0.1 and 1.0% by weight, preferably between 0.2 and 0.9% by weight,
of cereal meal in general between 20 and 90% by weight, preferably between 30 and 85% by weight,
of binder in general between 0 and 25% by weight, preferably between 2 and 20% by weight,
of supplementary agents in general between 0 and 5.0% by weight, preferably between 2 and 5.0% by weight.

If appropriate, the slug and snail baits according to the invention may contain the following constituents:
between 10 and 50% by weight, preferably between 20 and 40% by weight, of potato preparation,
between 2 and 15% by weight, preferably between 4 and 10% by weight, of yeast.

The slug and snail baits according to the invention are highly suitable for controlling terrestrial slugs and snails in agriculture and horticulture. They include all terrestrial slugs and snails which mostly occur as polyphagous pests on agricultural and horticultural crops. Important pests of this type are slugs such as Arion rufus, Arion ater and other Arionidae, Limax species, additionally field slugs such as Deroceras reticulatum and D. agreste from the family Limacidae and Agriolimacidae, and species from the family Milacidae, and also harmful snails such as those of the genus Cepaea, Discus, Helicigona and Helicella.

When controlling slugs and snails, the application rate of baits according to the invention can be varied within a substantial range. In general, one will use between 2 and 15 kg of slug and snail bait per hectare, preferably between 3 and 7 kg per hectare.

The slug and snail baits according to the invention can be applied by customary methods, such as, for example, by scattering and drilling.

The invention is illustrated by the examples which follow.

### EXAMPLES

1) Preparation of the slug and snail bait formula according to the invention:

The pulverulent constituents are premixed in a ploughshare mixer. To this end, 9500 g of hard wheatmeal with a particle size of below 250 μm, 209.03 g of iron(III) phosphate hydrate a) and 50 g of methiocarb c) are homogenized for 5 minutes. Thereafter, the solids mixture is transferred into a dough kneader.

Some 275 g of an approximately 60% phosphonic acid of the formula (I-1) (HEDP; commercial product from ZSM; pH 1) (a) are diluted with 1500 g of water and then slowly added into the dough kneader at room temperature, with stirring. When the addition is complete, stirring is continued for 15 minutes.

The homogeneous dough formed in this process is extruded at 40° C. under a pressure of 60 bar through a perforated disc with perforations of 2.2 mm diameter to give extrudates which are comminuted with the aid of rotating knives to give cylindrical pieces 2 to 3 mm in length. The material obtained is dried for 30 minutes in a fluidized bed by a stream of air whose temperature is increased continuously from 20° C. until, at the end of the drying process, the waste air has reached a temperature of 55° C. Thereafter, the product is allowed to cool to room temperature and stored for 3 days in the air without covering so that a moisture equilibrium is established in the pellets. In this manner, 10 000 g of slug and snail bait in the form of cylindrical pellets are obtained.

The per cent by weight of the active substances employed in the formulas according to the invention are specified as follows:

RB (Ready Bait): % by weight a) and/or b)+% by weight c)

Use Examples

### Example A

Acceptance Test in Controlled-Environment Cabinets
Test slugs: Anion spec.
Test crop: savoy cabbage cultivar Melissa
Test method: acceptance test, controlled-environment cabinet (15° C., 90% relative atmospheric humidity)
Treatment day: 07.06.2010 (Table 1a/2a)/23.08.2010 (Table 1a/2b)

Scattering of the bait formulation in test boxes. In this procedure, it was ensured that the slugs always had a sufficient amount of bait available. By way of alternative feed, the slugs were offered cabbage plants which were replaced regularly.

The test was evaluated 3, 7, 9 and 11 days and 7 days (1b/2b) after the application by determining the feeding damage (% feeding damage/plant evaluated as feeding protection) and the mortality. The data shown is the mean of the feeding protection (in the untreated control: 0% feeding damage) of the mortality.

RB: Ready Bait
inventive formula RB 1.84 (1.62+0.2): =1.62% (Fe(III) phosphate+phosphonic acid)+0.2% methiocarb
inventive formula RB 2.12 (1.62+0.5): =1.62% (Fe(III) phosphate+phosphonic acid)+0.5% methiocarb
inventive formula RB 2.32 (1.62+0.7): =1.62% (Fe(III) phosphate+phosphonic acid)+0.7% methiocarb
inventive formula: RB 2.52 (1.62+0.9): =1.62% (Fe(III) phosphate+phosphonic acid)+0.9% methiocarb
MTC 0.2: =methiocarb 0.2%
MTC 0.5: =methiocarb 0.5%
MTC 0.7: =methiocarb 0.7%
MTC 0.9: =methiocarb 0.9%
commercial product Biomol® RB 1.62: =1.62% (Fe(III) phosphate+phosphonic acid), according to formula (I-1), Bayer CropScience AG, Monheim, DE
commercial product Sluxx® RB 3: 3% (iron(III) phosphate+ethylenediamine chelating agent)), Neudorff GmbH KG, DE

TABLE 1a
Feeding protection [%]

| Days after | Untreated | | Inven- | Inven- | | | Inven- | Inven- |
|---|---|---|---|---|---|---|---|---|
| application/ | control | | tive | tive | | | tive | tive |
| feeding | (feeding | | formula | formula | Fe(III) | | formula | formula |
| protection | damage) | Biomol ® | RB 1.62 + | RB 1.62 + | phosphate | Sluxx ® | RB 3 + | RB 3 + |
| [%] | (%) | RB 1.62 | 0.5 | 0.9 | RB 3 | RB 3 | 0.5 | 0.9 |
| 3 DAT | 30 | 98 | 99 | 100 | 96 | 96 | 98 | 99 |
| 7 DAT | 85 | 91 | 93 | 97 | 76 | 86 | 86 | 94 |
| 9 DAT | 87 | 90 | 92 | 97 | 74 | 85 | 85 | 93 |
| 11 DAT | 90 | 87 | 90 | 97 | 71 | 84 | 83 | 92 |

TABLE 1b
Feeding protection [%]

| Days | | | | | | | | | |
|---|---|---|---|---|---|---|---|---|---|
| after | Untreated | Inven- | Inven- | Inven- | Inven- | | | | |
| application/ | control | tive | tive | tive | tive | | | | |
| feeding | (feeding | formula | formula | formula | formula | | | | |
| protection | damage) | RB 1.62 + | RB 1.62 + | RB 1.62 + | RB 1.62 + | Biomol | MTC | MTC | MTC |
| [%] | (%) | 0.2 | 0.5 | 0.7 | 0.9 | RB 1.62 | RB 0.2 | RB 0.5 | RB 0.9 |
| 4 DAT | 58 | 94 | 99 | 98 | 98 | 76 | 91 | 94 | 95 |

TABLE 2a
Mortality [%]

| | | | Inven- | Inven- | | Inven- | Inven- | |
|---|---|---|---|---|---|---|---|---|
| Days after | Untreated | | tive | tive | Fe(III) | tive | tive | |
| application/ | control | | formula | formula | phosphate + | formula | formula | |
| mortality | (cabbage | Biomol ®: | RB 1.62 + | RB 1.62 + | HEDP | RB 3 + | RB 3 + | Sluxx ® |
| [%] | only) | RB 1.62 | 0.5 | 0.9 | RB 3 | 0.5 | 0.9 | RB 3 |
| 3 DAT | 0 | 0 | 3 | 3 | 0 | 3 | 0 | 0 |
| 7 DAT | 0 | 0 | 53 | 77 | 0 | 20 | 40 | 57 |
| 9 DAT | 0 | 0 | 57 | 87 | 0 | 20 | 47 | 63 |
| 11 DAT | 0 | 0 | 57 | 90 | 0 | 20 | 50 | 87 |

TABLE 2b
Mortality [%]

| Days | | | | | | | | | |
|---|---|---|---|---|---|---|---|---|---|
| after | Untreated | Inven- | Inven- | Inven- | Inven- | | | | |
| application/ | control | tive | tive | tive | tive | | | | |
| mortality | (cabbage | RB 1.62 + | RB 1.62 + | RB 1.62 + | RB 1.62 + | Biomol | MTC | MTC | MTC |
| [%] | only) | 0.2 | 0.5 | 0.7 | 0.9 | RB 1.62 | RB 0.2 | RB 0.5 | RB 0.9 |
| 4 DAT | 0 | 23 | 90 | 80 | 83 | 0 | 20 | 67 | 83 |

### Example B

### Field Experiment on the Activity of Various Slug and Snail Baits

Description of the Experiment:

The experiment was carried out pursuant to EPPO Guideline PP 1/95(3). In each case 10 Tagetes plants were placed into boxes on an area with naturally occurring Anion slugs (common garden slug). The various slug baits were applied.

Dosage (Application Rate):
Inventive formula: Fe(III) phosphate+formula (I-1)+methiocarb: 0.5 g/m²
Commercial product Ferramol® (Fe(III) phosphate+ethylenediamine chelate, Neudorff GmbH KG, DE): 5 g/m²
Commercial product Biomol® (Fe(III) phosphate+phosphonic acid), Bayer CropScience AG, Monheim, DE): 5 g/m²,
Commercial product Mesurol® (methiocarb, Bayer CropScience AG, Monheim, DE): 0.5 g/m²

The feeding damage on the plants were determined on days 1, 4, 7, 14, 21, 28 after application, and the efficacy, i.e. the protection against feeding, was calculated. The results are compiled in Table 3.

Table 3 shows the known, moderate feeding protection of the phosphonic acid (in this case Ferramol® and Biomol®):

At an application rate of 5 g/m², a feeding protection of on average 60% is obtained 1-28 days after the application. In contrast, the combination of Fe(III) phosphate+phosphonic acid with 0.5% methiocarb leads, at an application rate of only 0.5 g/m², on average to a feeding protection of 89%. Therefore, the formula according to the invention shows the same activity level as Mesurol® (active substance methiocarb), despite the markedly reduced methiocarb content.

TABLE 3
Results of the field experiment
Efficacy (feeding protection) on days after application [%]

| | Dose | | | | | | |
|---|---|---|---|---|---|---|---|
| Product | [g/m²] | 1 | 4 | 7 | 14 | 21 | 28 |
| Untreated | | 0 | 0 | 0 | 0 | 0 | 0 |
| Ferramol ® | 5 | 26 | 93 | 87 | 78 | 52 | 17 |
| Biomol ® | 5 | 70 | 97 | 90 | 88 | 59 | 34 |
| Inventive formula: | 0.5 | 91 | 99 | 95 | 94 | 85 | 68 |
| 1.62 + 0.5 | | | | | | | |
| Mesurol ® | 0.5 | 91 | 99 | 99 | 99 | 95 | 60 |

### Example C

### Field Experiment on the Activity of Various Slug and Snail Baits

Description of the Experiment:

Lettuce (Lactuca sativa) was treated with the following slug and snail baits / application rates at planting and 7 days after planting:
Inventive formula RB 2.12 (1.62+0.5): =1.62% (Fe(III) phosphate+phosphonic acid)+0.5% methiocarb=>5 kg/ha
Inventive formula RB 2.12 (1.62+0.5): =1.62% (Fe(III) phosphate+phosphonic acid)+0.5% methiocarb=>7 kg/ha
Inventive formula RB 3.5 (3.0+0.5): =3.0% (Fe(III) phosphate+phosphonic acid)+0.5% methiocarb=>5 kg/ha
Commercial product Mesurol® Pro RB4: =4% methiocarb, Bayer CropScience AG, Monheim, DE=>3 kg/ha
Commercial product Ferrox® RB 3: 3% (Eisen(III) phosphate+phosphonic acid), Neudorff GmbH KG, DE=>5 kg/ha
Fe(III) phosphate+phosphonic acid RB 3:=>5 kg/ha

On day 13 after planting, the numbers of plants present was determined The results are compiled in Table 4.

TABLE 4
Results of the field experiment

| Product | Dose [kg/ha] | 13 |
|---|---|---|
| Untreated | | 36 |
| Inventive formula RB 1.62 + 0.5: | 5 | 75 |
| Inventive formula RB 1.62 + 0.5: | 7 | 69 |
| Inventive formula RB 3.0 + 0.5 | 5 | 58 |
| Mesurol ® Pro | 3 | 63 |
| Ferrox ® RB 3: | 5 | 60 |

1. A phosphonic acid formulation comprising:
a) phosphonic acid of formula (I) 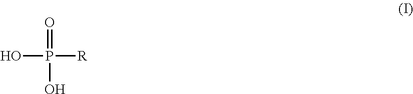
in which R represents C₁-C₁₀-alkyl,
which is monosubstituted or polysubstituted by identical or different substituents from the series PO₃H₂, CO₂H, OH, NH₂, CN, halogen, C₁-C₈-alkylamine or C₂-C₁₆-dialkylamine, and
which is optionally interrupted by 1-6 heteroatoms from the series N, O, S, P, with heteroatoms not being linked directly to each other;
and
ammonium, alkali metal, alkaline-earth metal salts,
and/or iron salts;
and/or
b) ammonium, alkali metal, alkaline-earth metal salts,
and/or iron salts of the phosphonic acid of formula (I),
and
c) methiocarb,
wherein the amount of a) and/or b) is from 0.5 to 10% by weight and the amount of c) is in the range of from 0.1 to 1% by weight.

2. The phosphonic acid formulation according to claim 1, wherein said phosphonic acid a) is a compound of formul (I-1)

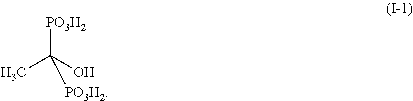

3. The phosphonic acid formulation according to claim 1, further comprising:
finely-particulate cereal meal, and/or
binder, and/or
a further supplementary substance.

4. The phosphonic acid formulation according to claim 1, further comprising:
potato preparation, and/or
yeast.

5. The phosphonic acid formulation according to claim 1, capable of being used for controlling terrestrial slugs and snails, wherein the formulation is capable of being applied to the habitat of the slugs and/or snails.

6. A method of controlling terrestrial slugs and snails, comprising allowing a phosphonic acid formulation according to claim 1, act on terrestrial slugs and/or snails and/or a habitat thereof.
